(19) United States
(12) Patent Application Publication
(10) Pub. No.: US 2026/0237703 A1
(43) Pub. Date: Aug. 13, 2026

(54) ASSEMBLY AND METHOD FOR USING AN EXCHANGE-MEMBRANE FUEL CELL AND AN ACID-CAPTURE DEVICE

(71) Applicant: SAFRAN POWER UNITS, TOULOUSE (FR)

(72) Inventors: Sofyane ABBOU, MOISSY-CRAMAYEL (FR); Marion SCOHY, MOISSY-CRAMAYEL (FR)

(73) Assignee: SAFRAN POWER UNITS, TOULOUSE (FR)

(21) Appl. No.: 18/693,260

(22) PCT Filed: Sep. 7, 2022
(86) PCT No.: PCT/EP2022/074777

§ 371 Date: Oct. 30, 2024

(30) Foreign Application Priority Data
Sep. 21, 2021 (FR) 2109909

(51) Int. Cl. H01M 8/0662; H01M 8/04119; H01M 8/04746; H01M 8/10

(52) U.S. Cl. CPC H01M 8/0662; H01M 8/04164; H01M 8/04761; H01M 2008/1095

(57) ABSTRACT

An assembly comprising a proton-exchange membrane fuel cell (1) comprising an anode inlet (Ea), a cathode inlet (Ec), an anode outlet (Sa) and a cathode outlet (Sc), said outlets (Sa, Sc) being configured to remove acid-containing exhaust gases (Ga, Gc), the assembly comprising at least one acid-capture device (2) mounted at least at one of the outlets (Sa, Sc) in order to extract at least some of the acid present in the exhaust gases (Ga, Gc) and discharge de-acidified exhaust gases (Ga*, Gc*).

### TECHNICAL FIELD

The present invention relates to the field of fuel cells of the proton-exchange membrane type known under its abbreviation PEMFC for “Proton-Exchange Membrane Fuel Cell”. In particular, the invention relates to a fuel cell intended to be embedded in an aircraft, in particular, to power electrical equipment participating in the propulsion of the aircraft.

In a known manner, in reference to FIG. 1, a fuel cell 1 comprises an anode inlet Ea, a cathode inlet Ec, an anode outlet Sa and a cathode outlet Sc. The anode inlet Ea receives, for example, dihydrogen while the cathode inlet Ec receives, for example, dioxygen in order to produce electricity at the terminals of the fuel cell 1 (not shown). Exhaust gases are discharged through the anode outlet Sa and the cathode outlet Sc.

Such a fuel cell 1 generally comprises membrane electrode assemblies (MEA) comprising a solid polymer membrane that acts as an electrolyte. To improve the proton conductivity of the membrane, it is known to dope the membrane with acid, in particular phosphoric acid.

The exhaust gases, which are discharged via the anode outlet Sa and the cathode outlet Sc, mainly contain oxygen, nitrogen, hydrogen and water vapor as well as traces of acid (a few ppm). For a high-temperature fuel cell, i.e. operating at temperatures between 120° C. and 200° C., the exhaust gases have high temperatures and are corrosive due to traces of acid, which is very demanding for equipment located downstream (valves Va, Vc, sensors, etc.), which reduces their service life.

Additional disadvantages also arise during the start/stop phases of the fuel cell 1. During these phases, the temperature of the fuel cell is below the operating temperature and residual acid in the exhaust lines of the fuel cell 1 may crystallize and clog the anode outlet Sa and cathode outlet Sc, the exhaust lines Ca, Cc, as well as the equipment downstream of the fuel cell 1. Acid crystallization can therefore cause corrosion, seizure or blockage of certain exhaust pipelines Cc, Ca and downstream equipment, which is a disadvantage.

An immediate solution to eliminate this disadvantage is to offer membranes without acid doping. However, such a solution is irrelevant as it impairs proton conductivity. Another immediate solution is to use membranes that have better retention of phosphoric acid, but there are no mature and efficient technical solutions to date.

Thus, the invention aims to eliminate at least some of these disadvantages.

### DESCRIPTION OF THE INVENTION

The invention relates to an assembly comprising a proton-exchange membrane fuel cell comprising an anode inlet, a cathode inlet, an anode outlet and a cathode outlet, said outlets being configured to discharge exhaust gases comprising acid.

The assembly is remarkable in that it comprises at least one acid-capture device mounted at least at one of the outlets in order to extract at least some of the acid present in the exhaust gases and discharge de-acidified exhaust gases.

Advantageously, an acid-capture device is mounted at least at one of the outlets so as to extract the acid from the exhaust gases in order to avoid damage to downstream equipment such as a valve or a sensor. Thanks to the invention, the fuel cell is advantageously not modified, only an auxiliary acid-capture device may be added in an exhaust line of the fuel cell.

Preferably, the acid-capture device is mounted at the cathode outlet to extract at least some of the acid present in the cathode exhaust gas. This is advantageous as the cathode outlet is responsible for the majority of acid discharges.

According to one aspect of the invention, the assembly further comprises an acid-capture device mounted at the anode outlet. In other words, a first acid-capture device is mounted at the anode outlet and a second acid-capture device is mounted at the cathode outlet. Thus, all of the acid waste is treated.

According to one aspect of the invention, the acid-capture device comprises at least one basic source configured to neutralize the acid present in the exhaust gases. A basic source advantageously makes it possible to extract the acid by neutralizing it by a basic source, the addition of a base compensating for the acidity.

Preferably, the basic source comprises at least one base in solid and porous form. Such a basic source is easy to implement and advantageous for exhaust gases with low water vapor content.

Preferably, the basic source comprises one or more of the following bases: NaOH, KOH and Ca2. Such bases are simple and convenient to handle.

According to one aspect of the invention, the acid-capture device comprises at least one regulating valve configured to control a passage or bypass of the basic source. Thus, the valve makes it possible to control the consumption of the basic source sparingly.

Preferably, the valve is controllable, in particular, according to a fuel cell operating parameter. Thus, the regulation is advantageously automatic.

According to another aspect of the invention, the acid-capture device comprises at least one condensation enclosure comprising a liquid wherein the exhaust gases are injected so as to condense and dilute the acid. Such a condensation chamber is advantageous because it allows the water and acid in the exhaust gases to be captured optimally. In addition, such a condensation chamber allows the exhaust gases to be cooled optimally, which is advantageous for a high-temperature fuel cell.

Preferably, the acid-capture device comprises at least one cooling circuit configured to cool the liquid of the condensation enclosure in order to achieve optimal condensation over time.

Preferably, the acid-capture device comprises at least one sampling circuit of the gas phase of the condensation enclosure. Thus, de-acidified gases may be discharged downstream.

According to one aspect of the invention, the acid-capture device comprises at least one heat exchanger configured to cool the de-acidified exhaust gases. This is advantageous for a high-temperature fuel cell.

Preferably, a heat exchanger is mounted downstream of the basic source in order to avoid acid condensation that could damage the heat exchanger.

Preferably, the acid-capture device comprises at least one phase separator configured to recover the liquid phase comprising acid and water from the exhaust gases and to discharge a de-acidified gas phase.

Preferably, the acid-capture device comprises at least one acid storage tank configured to collect the liquid phase.

Preferably, the assembly comprises a first acid-capture device with a basic source mounted at the anode outlet and a second acid-capture device with a condensation tank mounted at the cathode outlet. The use of two different capture devices allows adaptation to the specifics of each fuel cell outlet.

Preferably, the fuel cell comprises at least one membrane doped with acid, preferably phosphoric acid.

The invention further relates to a method of using an assembly as presented previously, comprising steps consisting of:
extracting at least some of the acid in the exhaust gases from at least one of the fuel cell outlets and
discharging de-acidified exhaust gases.

### DESCRIPTION OF THE FIGURES

The invention will be better understood upon reading the following description, given as an example, and by referring to the following figures, given as non-limiting examples, wherein identical references are given to similar objects.

FIG. 1 is a schematic representation of a fuel cell according to the prior art.

FIG. 2 is a schematic representation of an assembly of a fuel cell and two acid-capture devices according to the invention.

FIG. 3 is a schematic representation of a first embodiment of the capture device.

FIG. 4 is a schematic representation of a second embodiment of a capture device.

FIG. 5 is a schematic representation of a third embodiment of the capture device.

FIG. 6 is a schematic representation of a fourth embodiment of a capture device.

FIG. 7 is a schematic representation of a configuration of a fuel cell and two capture devices.

FIG. 8 is a schematic representation of a fifth embodiment of a capture device.

FIG. 9 is a schematic representation of a configuration of a fuel cell and two capture devices according to FIG. 8.

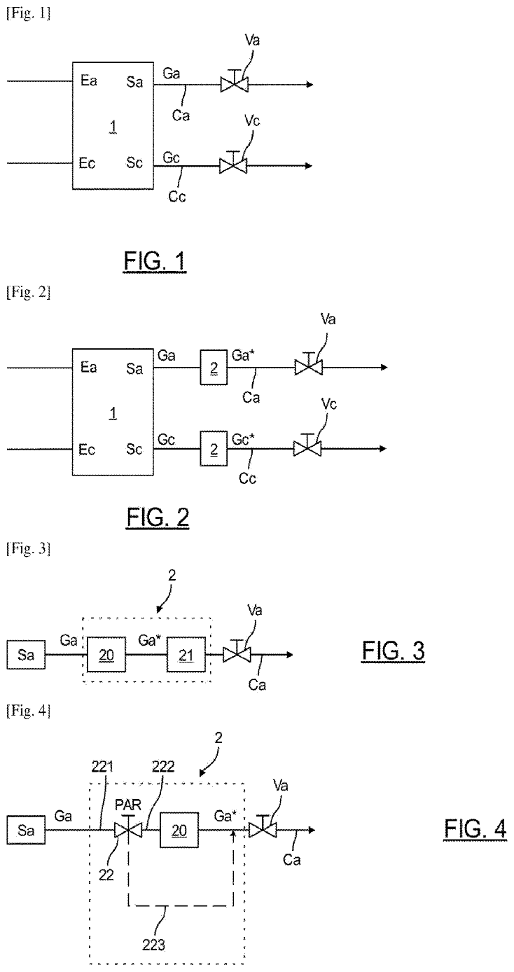

It should be noted that the figures set out the invention in detail in order to implement the invention, said figures may of course be used to better define the invention where applicable.

### DETAILED DESCRIPTION OF THE INVENTION

The invention relates to a fuel cell of the proton-exchange membrane type known under its abbreviation PEMFC for “Proton-Exchange Membrane Fuel Cell”.

The invention will be presented for a high-temperature fuel cell, i.e. operating at temperatures between 120° C. and 200° C., but the invention also applies to a low-temperature fuel cell operating at temperatures between 40° C. and 100° C. In particular, the invention relates to a fuel cell intended to be embedded in an aircraft, in particular, to power electrical equipment participating in the propulsion of said aircraft.

In a known manner, the fuel cell 1 comprises an anode inlet Ea, a cathode inlet Ec, an anode outlet Sa of anode exhaust gas Ga and a cathode outlet Sc of cathode exhaust gas Gc. The anode inlet Ea receives, for example, dihydrogen while the cathode inlet Ec receives, for example, dioxygen in order to produce electricity at the terminals of the fuel cell 1 (not shown). In this example, the fuel cell 1 comprises membrane electrode assemblies (MEA) comprising at least one membrane doped with acid, in particular phosphoric acid, so as to improve the proton conductivity of the membrane, preferably a solid polymer membrane that acts as an electrolyte. The exhaust gases Ga, Gc, which are discharged via the anode outlet Sa and the cathode outlet Sc, mainly contain oxygen, nitrogen, hydrogen and water vapor, but also traces of acid (a few ppm).

For a high-temperature fuel cell, i.e. operating at temperatures between 120° C. and 200° C., the exhaust gases Ga, Gc are corrosive (pH of about 1.5 to 2) and have high temperatures. During tests performed for a high-temperature fuel cell with an electrical output of 20 kW, the amount of phosphoric acid lost in the exhaust gases Ga, Gc can reach up to 30 mg/hour depending on the operating conditions. Interestingly, it has been observed that nearly 90% of acid discharges occur at the cathode outlet Sc. Such a fuel cell 1 is known to those skilled in the art and will not be presented in more detail.

According to the invention, it is proposed to mount at least one acid-capture device 2 at one or more of the anode Sa and cathode Sc outlets of the fuel cell 1 to extract at least some of the acid present in the exhaust gases Ga, Gc. In other words, the acid-capture device 2 receives an exhaust gas Ga, Gc at the inlet and emits a de-acidified exhaust gas Ga*, Gc* at the outlet.

Advantageously, the fuel cell 1 is not modified and the invention may apply to fuel cells already in circulation.

In this example, in reference to FIG. 2, an anode exhaust line Ca connects the anode outlet Sa to an anode exhaust valve Va. Similarly, a cathode exhaust line Cc connects the cathode outlet Sc to a cathode exhaust valve Vc, it goes without saying that other equipment could be mounted in the exhaust lines Ca, Cc, e.g. sensors.

In this example, in reference to FIG. 2, an acid-capture device 2 is mounted at each outlet Sa, Sc but it goes without saying that only one outlet Sa, Sc could be provided with an acid-capture device 2. Preferably, the cathode outlet Sc is connected to such an acid-capture device 2 since most of the acid discharges originate from the cathode as explained previously.

As will be presented in detail later, the acid-capture device 2 may implement various technologies, in particular, a basic source 20 (FIGS. 3-5), a condensation enclosure 30 (FIG. 6) or a phase separator 41 (FIG. 8). The various technologies will be presented independently, but it goes without saying that they could be coupled within the same acid-capture device 2.

Subsequently, the different embodiments of the acid-capture device 2 will be presented in relation to the anode outlet Sa for the sake of concision, but they apply to either one or the other. The advantages related to the use of a particular embodiment with the anode outlet Sa and/or the cathode outlet Sc will be presented individually.

In reference to FIG. 3, according to a first embodiment, the acid-capture device 2 comprises a basic source 20 configured to neutralize the acid present in the exhaust gases Ga. In a known manner, a basic source 20 has by nature a pH greater than 7, preferably greater than 11. Preferably, the basic source 20 comprises one or more of the following bases: NaOH, KOH and Ca(OH)2.

Preferably, the basic source 20 comprises an enclosure in which the base(s) is/are stored in a solid and porous form. Such a porosity advantageously allows the exhaust gases Ga to pass through the basic source 20 without disturbing the discharging of the exhaust gases Ga. On contact with the base(s), the traces of acid are neutralized and trapped in the enclosure. As a result, de-acidified exhaust gases Ga* have a higher pH (ideally close to 7), which prevents damage to downstream equipment.

According to one variant, in reference to FIG. 3, the acid-capture device 2 comprises a pH indicator 21 configured to indicate the pH or pH range of the de-acidified exhaust gases Ga*. Preferably, a visual indicator, in particular colorimetric, is used. Such a pH indicator 21 is advantageous to indicate that the basic source 20 is consumed and must be replaced. A pH close to that of acid indicates that the base contained in the basic source 20 has to be replaced.

For a fuel cell 1 with an electrical output of 20 KW, the amount of phosphoric acid discharged into the exhaust gases Ga, Gc can be up to 30 mg/hour. The amount of base required to neutralize this acid would therefore be around 300 mg/hour; i.e. 30 kg for 100 hours of operation.

According to a preferred aspect, in reference to FIG. 4 representing a second embodiment, the acid-capture device 2 comprises a regulating valve 22 comprising an inlet 221 connected to said anode outlet Sa, a first outlet 222 connected to an inlet of the basic source 20 and a second outlet 223 connected to an outlet of the basic source 20 in order to bypass it. The first outlet 222 is connected to the anode exhaust line Ca upstream of the basic source 20 while the second outlet 223 is connected to the anode exhaust line Ca downstream of the basic source 20.

Such a regulating valve 22 makes it possible to regulate the use of the basic source 20 in order to control its consumption. By way of example, the regulating valve 22 makes it possible to use the basic source 20 mainly during the start/stop phases of the fuel cell 1 and to leave it at rest during a nominal operating phase of the fuel cell 1.

Preferably, the regulating valve 22 is controllable, in particular, according to an operating parameter PAR of the fuel cell 1. For example, during the start/stop phases of the fuel cell 1, an operating parameter PAR is emitted by the fuel cell 1 (or by an associated calculator) to activate a de-acidification by the basic source 20. Conversely, during a nominal operating phase of the fuel cell 1, an operating parameter PAR is emitted by the fuel cell 1 (or by an associated calculator) to bypass the basic source 20. Thus, the basic source 20 is consumed sparingly.

The addition of a regulating valve 22 allowing a bypass of the basic source 20 makes it possible to target neutralization of the acid during specific operating phases, i.e., when the risk of acid crystallization is the greatest given the temperature drop. Thus, according to the application, the desired power, the aircraft mission profile and the mass/volume constraints, regular replacement operations of the basic source 20 are to be planned.

It goes without saying that a regulating valve 22 may be used in various embodiments of the capture device 2 so as to regulate the neutralization of the acid.

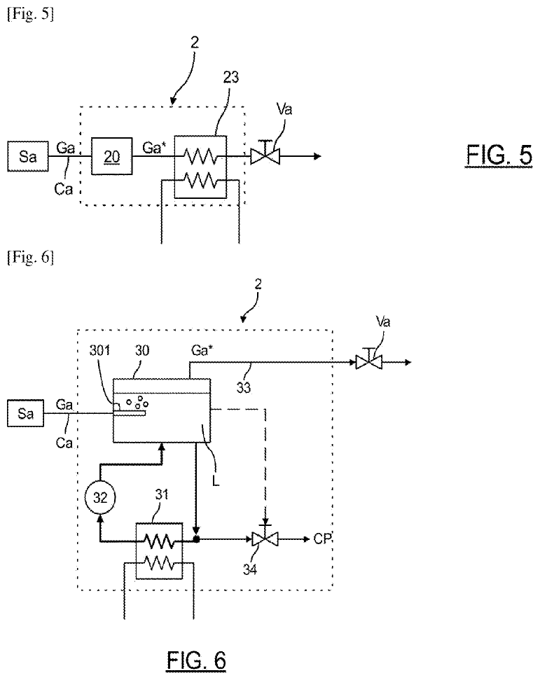

In reference to FIG. 5, according to a third embodiment, the acid-capture device 2 comprises a heat exchanger 23 that is configured to cool the de-acidified exhaust gases Ga* preferably to a temperature below 80° C., which preserves the downstream equipment. Preferably, the heat exchanger 23 is mounted downstream of the basic source 20 in order to avoid condensing acid that could damage the heat exchanger 23. Nevertheless, it goes without saying that the heat exchanger 23 could also be integrated into the basic source 20. The heat exchanger 23 can implement different cooling technologies (forced convection, liquid cooling, etc.).

The use of a basic source 20, according to one of the first three embodiments, is particularly suitable for the anode outlet Sa since the proportion of water produced by the electrochemical reaction is negligible. The use of a basic source 20, of a simple and convenient design, is advantageous for treating a reduced amount of liquid that will consume little of the basic source 20.

According to a fourth embodiment, in reference to FIG. 6, the acid-capture device 2 comprises a condensation enclosure 30 comprising a liquid L, in particular water, wherein the exhaust gases Ga of said outlet Sa are injected. Thus, the exhaust gases Ga are cooled when they are injected into the liquid L, which makes it possible to condense the traces of acid but also the water present in the water vapor. The traces of acid may be optimally extracted by dilution in liquid L.

As shown in FIG. 6, the acid-capture device 2 comprises a cooling circuit (thick line) configured to cool the liquid L of the condensation enclosure 30. In this example, the cooling circuit comprises a heat exchanger 31 as well as a pump 32. Liquid L heated in the condensation chamber 30 is thus cooled by the heat exchanger 31 and then injected back into the condensation chamber 30 by the pump 32. The acid-capture device 2 further comprises a sampling circuit 33 of the gas phase of the condensation chamber 30 so as to recover the de-acidified cooled gases Ga*.

The condensation enclosure 30 comprises an injector, immersed in the liquid, which comprises a diffuser 301, preferably cylindrical, allowing the diffusion by microleaks of the exhaust gases Ga into the liquid L, for example, through an alloy or sintered ceramic. Advantageously, the acid (particularly phosphoric acid) is highly soluble in hot water, which allows it to be trapped. Micro-leak diffusion increases the exchange area and enables optimal cooling of the exhaust gases Ga.

This embodiment is particularly suitable for the cathode outlet Sc of which the cathode exhaust gases Gc comprises a large amount of water vapor. Water from the water vapor is condensed in the condensation enclosure 30, which increases the amount of liquid L in the condensation enclosure 30 over time. For this purpose, an overflow device 34 is provided, here a valve connected to a purge circuit CP, allowing liquid L to be discharged from the condensation chamber 30 when the liquid level is too high. In this example, the overflow device 34 is also connected to the cooling circuit. Using the cooling circuit and the overflow device 34 together makes it possible to maintain a constant, temperature-controlled water volume. For a fuel cell 1 having a power of 20 kW such as presented previously, it is estimated that 11 liters of liquid water per hour may be recovered at the cathode outlet Sc if all the water vapor produced by the electrochemical reaction is recovered and condensed.

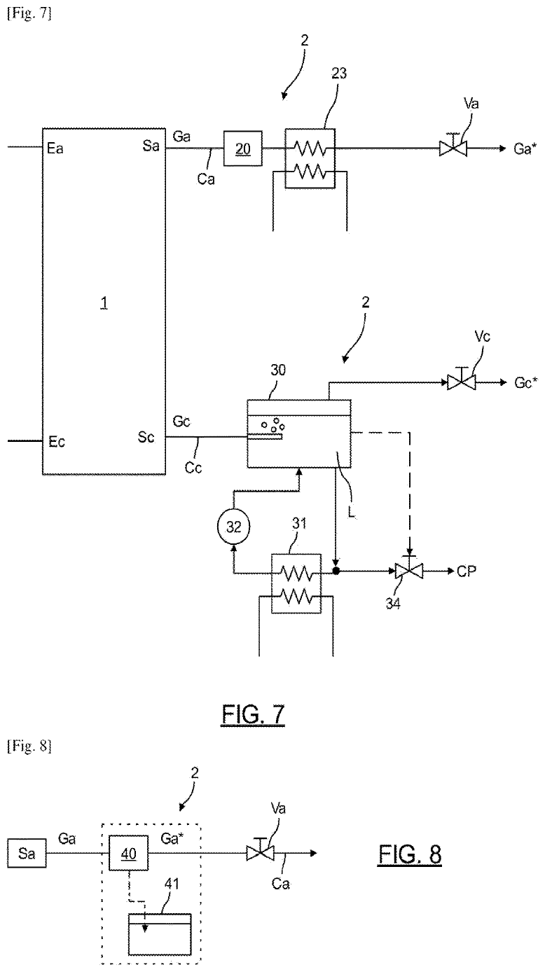

In reference to FIG. 7, a first configuration of a fuel cell 1 is shown wherein the anode outlet Sa is associated with an acid-capture device 2 comprising a basic source 20 in order to benefit from its small size and simple design. Such a basic source 20 is suitable given that the proportion of water produced by the electrochemical reaction is low as well as the amount of acid discharges. The basic source 20 may thus be used sparingly. Conversely, the cathode outlet Sc is associated with an acid-capture device 2 comprising a condensation enclosure 30 in order to benefit from its high efficiency to collect the water produced by the electrochemical reaction as well as the acid discharges which are greater on the cathode side.

According to another embodiment, in reference to FIG. 8, the acid-capture device 2 comprises at least one phase separator 40 configured to recover the liquid phase comprising traces of acid and water and allow the de-acidified gas phase Ga* to pass through. Preferably, the phase separator 40 is in the form of a condenser.

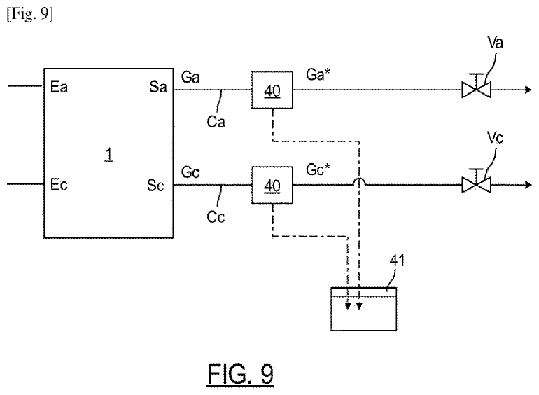

Preferably, the acid-capture device 2 further comprises an acid storage tank 41 configured to collect the acid liquid phase from one or more phase separators 40. In practice, the most acidic pH at the cathode outlet is 4.5. It goes without saying that the phase separators 40 could also be connected to a purge circuit. In reference to FIG. 9, a second configuration of a fuel cell 1 is shown wherein the anode outlet Sa and the cathode outlet Sc are both associated with phase separators 40 that are connected to an acid storage tank 41 that is common.

Thanks to the invention, during operation of the fuel cell 1, the exhaust gases Ga, Gc are treated so as to extract at least some of the discharged acid. This makes it possible to protect equipment, located downstream of fuel cell 1, which receives de-acidified, preferably cooled, exhaust gases Ga*, Gc*.

1.-15. (canceled)

16. An assembly comprising a proton-exchange membrane fuel cell comprising an anode inlet, a cathode inlet, an anode outlet and a cathode outlet, said anode outlet and said cathode outlet being configured to discharge exhaust gases comprising acid, assembly characterized by the fact that it comprises at least one acid-capture device mounted to at least one of the outlets to extract at least some of the acid in the exhaust gases and discharge de-acidified exhaust gases.

17. The assembly according to claim 16, wherein the acid-capture device is mounted at the cathode outlet to extract at least some of the acid present in the cathode exhaust gases.

18. The assembly according to claim 17, further comprising an acid-capture device mounted at the anode outlet.

19. The assembly according to claim 16, wherein the acid-capture device comprises at least one basic source configured to neutralize the acid present in the exhaust gases.

20. The assembly according to claim 19, wherein the basic source comprises at least one base in solid and porous form.

21. The assembly according to claim 19, wherein the basic source comprises one or more of the following bases: NaOH, KOH and Ca(OH)2.

22. The assembly according to claim 19, wherein the acid-capture device comprises at least one regulating valve configured to control a passage or bypass of the basic source.

23. The assembly according to claim 22, wherein the valve is controllable.

24. The assembly according to claim 22, wherein the valve is controllable according to an operating parameter (PAR) of the fuel cell (1).

25. The assembly according to claim 16, wherein the acid-capture device comprises at least one condensation enclosure comprising a liquid wherein the exhaust gases are injected so as to condense and dilute the acid.

26. The assembly according to claim 25, wherein the acid-capture device comprises at least one cooling circuit configured to cool the liquid of the condensation enclosure.

27. The assembly according to claim 26, wherein the acid-capture device comprises at least one heat exchanger configured to cool the de-acidified exhaust gases.

28. The assembly according to claim 26, wherein the acid-capture device comprises at least one phase separator configured to recover the liquid phase comprising the acid and water from the exhaust gases and to discharge a de-acidified gas phase.

29. The assembly according to claim 28, wherein the acid-capture device comprises at least one acid storage tank configured to collect the liquid phase.

30. The assembly comprising a first acid-capture device according to claim 29 mounted at the anode outlet and a second acid-capture device according to claim 20 mounted at the cathode outlet.

31. A method of using an assembly according to claim 16, comprising steps consisting of:
extracting at least part of the acid present in the exhaust gases from at least one of the outlets) of the fuel cell, and
discharging de-acidified exhaust gases.
